(19) United States
(12) Patent Application Publication
(10) Pub. No.: US 2026/0072204 A1
(43) Pub. Date: Mar. 12, 2026

(54) POLARIZING PLATE AND OPTICAL DISPLAY APPARATUS

(71) Applicant: SAMSUNG SDI CO., LTD., Yongin-si (KR)

(72) Inventors: Jun Mo KOO, Suwon-si (KR); Jin Joo KIM, Suwon-si (KR); Mun Bo KO, Suwon-si (KR); Kwang Ho SHIN, Suwon-si (KR)

(21) Appl. No.: 19/322,502

(22) Filed: Sep. 8, 2025

(30) Foreign Application Priority Data
Sep. 9, 2024 (KR) 10-2024-0122473

(51) Int. Cl. G02B 5/30

(52) U.S. Cl. CPC G02B 5/3016

(57) ABSTRACT

A polarizing plate and an optical display apparatus including the polarizing plate are provided. The polarizing plate includes a polarizer and a retardation layer on one surface of the polarizer. The polarizing plate has a cross transmittance of 1% or less at a wavelength of 600 nm, and the retardation layer includes a cholesteric liquid crystal layer, where an angle formed by a slow axis of the cholesteric liquid crystal layer at a wavelength of 450 nm with respect to a slow axis of the cholesteric liquid crystal layer at a wavelength of 550 nm is less than or equal to 5°, and an angle formed by a slow axis of the cholesteric liquid crystal layer at a wavelength of 650 nm with respect to the slow axis of the cholesteric liquid crystal layer at a wavelength of 550 nm is less than or equal to 5°.

### CROSS-REFERENCE TO RELATED APPLICATION

The present application claims priority to and the benefit of Korean Patent Application No. 10-2024-0122473, filed on Sep. 9, 2024, in the Korean Intellectual Property Office, the entire disclosure of which is incorporated herein by reference.

### BACKGROUND

### 1. Field

One or more embodiments of the present disclosure relate to a polarizing plate and an optical display apparatus.

### 2. Description of the Related Art

A light emitting diode display including an organic light emitting diode may include a polarizing plate to improve optical properties. The polarizing plate includes a polarizer and a retardation layer arranged on one surface of the polarizer.

In some cases, the retardation layer may be composed of a single layer. In some cases, the retardation layer may be a stack of a negative dispersion retardation layer and a positive C retardation layer to improve reflected colors. When the polarizing plate including the stack is applied to an optical display apparatus, a screen of the optical display apparatus may appear red and blue depending on the type of panel for the optical display apparatus and arrangement of pixels in the optical display apparatus. Therefore, it is desirable to prevent the screen of the optical display apparatus from appearing red and blue.

### SUMMARY

One or more aspects of embodiments of the present disclosure are directed toward a polarizing plate that allows a screen to appear green while preventing blue and red colors from being visible as reflected colors on lateral sides thereof and may reduce a difference in reflected color between the left and right sides when applied to an optical display apparatus. Additional aspects will be set forth in part in the description which follows and, in part, will be apparent from the description, or may be learned by practice of the presented embodiments of the disclosure.

According to one or more embodiments of the present disclosure, a polarizing plate is provided.

The polarizing plate includes a polarizer and a retardation layer stacked on a (e.g., one) surface of the polarizer, wherein the polarizing plate has a cross transmittance of 1% or less at a wavelength of 600 nm, the retardation layer includes a cholesteric liquid crystal layer, an angle formed by a slow axis of the cholesteric liquid crystal layer at a wavelength of 450 nm with respect to a slow axis of the cholesteric liquid crystal layer at a wavelength of 550 nm is less than or equal to 5°, and an angle formed by a slow axis of the cholesteric liquid crystal layer at a wavelength of 650 nm with respect to the slow axis of the cholesteric liquid crystal layer at a wavelength of 550 nm is less than or equal to 5°.

According to one or more embodiments of the present disclosure, there is provided an optical display apparatus.

The optical display apparatus includes the polarizing plate according to one or more embodiments of the present disclosure.

Embodiments of the present disclosure provide a polarizing plate that allows a screen to appear green while preventing blue and red colors from being visible as reflected colors on lateral sides thereof and may reduce a difference in reflected color between the left and right sides when applied to an optical display apparatus.

### BRIEF DESCRIPTION OF DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and benefits of the present disclosure will become more apparent to those of ordinary skill in the art from the following exemplary embodiments thereof described in detail with reference to the accompanying drawings.

FIG. 1 is a cross-sectional view of a polarizing plate according to one or more embodiments of the present disclosure.

FIG. 2 is a cross-sectional view of a polarizing plate according to one or more embodiments of the present disclosure.

FIG. 3 is a cross-sectional view of a polarizing plate according to one or more embodiments of the present disclosure.

FIG. 4 shows an example cholesteric alignment liquid crystal layer according to one or more embodiments of the present disclosure.

FIG. 5 is a graph depicting evaluation results of reflected color values a* and b* in application of a polarizing plate according to one or more embodiments of the present disclosure, wherein ▪ is color coordinates of reflected color a* and b* values at a lateral side (8°), ▴ is color coordinates of reflected color a* and b* values at a lateral side (30°), ● is color coordinates of reflected color a* and b* values at a lateral side (45°), and ★ is color coordinates of reflected color a* and b* values at a lateral side (60°).

FIG. 6 is a graph depicting evaluation results of reflected color values a* and b* in application of a polarizing plate including a stack of a typical negative dispersion retardation layer and a positive C layer, wherein ▪ is color coordinates of reflected color a* and b* values at a lateral side (8°), ▴ is color coordinates of reflected color a* and b* values at a lateral side (30°), ● is color coordinates of reflected color a* and b* values at a lateral side (45°), and ★ is color coordinates of reflected color a* and b* values at a lateral side (60°).

### DETAILED DESCRIPTION

Hereinafter, example embodiments of the present disclosure will be described with reference to the accompanying drawings. It should be understood that the present disclosure may be embodied in various ways and is not limited to the following embodiments. It should be further understood that the following embodiments are provided for complete disclosure and thorough understanding of the disclosure by those skilled in the art. In the drawings, the width or thickness of each element may be exaggerated or reduced for descriptive convenience and clarity only. Like components will be denoted by like reference numerals throughout the disclosure, and duplicative descriptions thereof may not be repeated for conciseness.

Herein, spatially relative terms such as “upper” and “lower” are defined with reference to the accompanying drawings. Thus, it will be understood that the term “upper surface” can be used interchangeably with the term “lower surface”, and when an element such as a layer or a film is referred to as being placed “on” another element, it may be directly placed on the other element, or one or more intervening element(s) may be present therebetween. In contrast, when an element is referred to as being placed “directly on” another element, there are no intervening element(s) therebetween.

The terminology used herein is for the purpose of describing example embodiments and is not intended to limit the present disclosure. As used herein, the singular forms “a”, “an”, and “the” are intended to include the plural forms as well, unless the context specifically indicates otherwise.

Herein, “in-plane retardation (Re)” of a cholesteric liquid crystal layer is measured by calculating the Mueller matrix from Sᵢₙ×M=Sₒᵤₜ at each measurement wavelength, and slow axis and Re are obtained by matrix calculation, wherein
Sᵢₙ: Stokes Vector of incident beam, M: Mueller matrix, Sₒᵤₜ: Stokes vector of reflected beam.

In one or more embodiments of the present disclosure, the measurement wavelength of the in-plane retardation may be a wavelength of 450 nm, 550 nm, or 650 nm.

Herein, an axis along which the index of refraction of an optical element in the in-plane direction attains a maximum level will be defined as the slow axis, and an axis along which the index of refraction of the optical element in the in-plane direction attains a minimum level will be defined as the fast axis.

As used herein, “(meth)acrylic” refers to acrylic and/or methacrylic.

As used herein to represent a specific numerical range, “X to Y” means “greater than or equal to X and less than or equal to Y (X≤ and ≤Y)”.

In general, an antireflection polarizing plate may include a polarizer and a stack of a negative dispersion retardation layer and a positive C layer stacked on a (e.g., one) surface of the polarizer. When the antireflective polarizing plate is applied to an optical display apparatus, the negative dispersion retardation layer fails to achieve complete absorption of blue light and red light, causing a phenomenon that a screen appears blue and/or red when viewed from a lateral side.

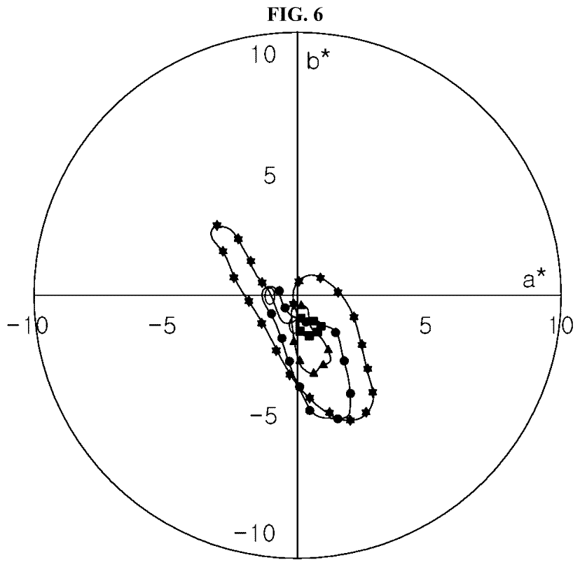

FIG. 6 is a graph depicting evaluation results of reflected color values a* and b* in application of a polarizing plate including a stack of a typical negative dispersion retardation layer and a positive C layer.

Referring to FIG. 6, it can be seen that the reflected color values a* and b* are concentrated in blue and red colors according to azimuth angles of 8°, 30°, 45°, and 60°.

In general, the above phenomenon is not easily observed on a large-area optical display apparatus. However, the above phenomenon can be easily observed on a small-area optical display apparatus, such as a notebook or a tablet.

The polarizing plate according to one or more embodiments of the present disclosure can, however, prevent appearance of blue and red colors according to azimuth angle on a screen by allowing the screen to appear green, when applied to an optical display apparatus. Therefore, when applied to the optical display apparatus, the polarizing plate may prevent a difference in reflected color according to viewing angle by allowing the overall screen to appear green without appearance of blue and red colors.

In this regard, when the polarizing plate according to one or more embodiments is applied to an optical display apparatus, the optical display apparatus has a reflected color a* value of −2.5 to 2 and a reflected color value b* value of −2 to 3 at the entire viewing angle, for example, at a lateral incidence angle of 8°, and a reflected color a* value of 0 or less and a reflected color value b* value of 0 or more at a lateral incidence angle of 60°.

The polarizing plate includes a cholesteric liquid crystal layer as a retardation layer arranged between a polarizer and a panel (e.g., screen) for an optical display apparatus, in which an angle formed by a slow axis of the cholesteric liquid crystal layer at a wavelength of 450 nm with respect to a slow axis of the cholesteric liquid crystal layer at a wavelength of 550 nm, an angle formed by a slow axis at of the cholesteric liquid crystal layer at a wavelength of 650 nm with respect to the slow axis of the cholesteric liquid crystal layer at a wavelength of 550 nm, and a cross transmittance of the polarizing plate at a wavelength of 600 nm are adjusted.

According to one or more embodiments, the polarizing plate may include a polarizer and a retardation layer stacked on a (e.g., one) surface of the polarizer, wherein the polarizing plate has a cross transmittance of 1% or less at a wavelength of 600 nm, the retardation layer includes a cholesteric liquid crystal layer, an angle formed by a slow axis of the cholesteric liquid crystal layer at a wavelength of 450 nm with respect to a slow axis of the cholesteric liquid crystal layer at a wavelength of 550 nm is less than or equal to 5°, and an angle formed by a slow axis of the cholesteric liquid crystal layer at a wavelength of 650 nm with respect to the slow axis of the cholesteric liquid crystal layer at a wavelength of 550 nm is less than or equal to 5°.

### Light Transmittance of Polarizing Plate

The polarizing plate has a cross transmittance (Tc) of 1% or less at a wavelength of 600 nm. With a cross transmittance of 1% or less at a wavelength of 600 nm among several wavelengths, the polarizing plate may increase the degree of absorption of green light when external light enters the polarizing plate, thereby preventing the phenomenon that the reflected color values become blue and red while allowing the reflected color values to become green on the entire screen.

In one or more embodiments, the polarizing plate may have a cross transmittance of 0 to 1%, 0 to 0.5%, 0.1% to 0.5%, or 0.3% to 0.5% at a wavelength of 600 nm.

The cross transmittance at a wavelength of 600 nm may be determined not only by the cholesteric liquid crystal layer, but also by a protective layer, a bonding layer, and the like, which may be included in the polarizing plate, and may be realized mainly by adjusting the cross transmittance of the polarizer at a wavelength of 600 nm. A method of adjusting the cross transmittance of the polarizer at a wavelength of 600 nm will be described in more detail below.

The polarizing plate may have a single light transmittance (Ts) of 40% to 47%, for example, 42% to 46%, at a wavelength of 550 nm. Within this range, the effect of the polarizing plate described above may be easily realized.

The polarizing plate may have a single light transmittance of 3% or less, for example, 0 to 3%, at a wavelength of 380 nm. Within this range, it may prevent damage to a light emitting diode by external light. A single light transmittance of 3% or less at a wavelength of 380 nm may be realized by adding a UV absorbent to at least one of the polarizer, the cholesteric liquid crystal layer, or the protective layer in the polarizing plate.

### Cholesteric Liquid Crystal Layer

The inventors of the present disclosure confirmed that, although the polarizing plate having a crossed light transmittance of 1% or less at a wavelength of 600 nm can make the entire screen appear green by increasing the degree of absorption of green light, there is a limitation in realizing such an effect. The cholesteric liquid crystal layer may increase the degree of absorption of green light such that the reflected color value becomes green on the entire screen and there is no difference in reflected color value between the left and right sides.

For example, an angle formed by a slow axis of the cholesteric liquid crystal layer at a wavelength of 450 nm (hereinafter referred to as “angle A”) with respect to a slow axis of the cholesteric liquid crystal layer at a wavelength of 550 nm is less than or equal to 5°, and an angle formed by a slow axis of the cholesteric liquid crystal layer at a wavelength of 650 nm (hereinafter referred to as “angle B”) with respect to the slow axis of the cholesteric liquid crystal layer at a wavelength of 550 nm is less than or equal to 5°.

Here, since the angle A is an absolute value of the angle formed by the slow axis of the cholesteric liquid crystal layer at a wavelength of 450 nm with respect to the slow axis of the cholesteric liquid crystal layer at a wavelength of 550 nm, the angle A may be in the range of 0° to 5°.

Here, since the angle B is an absolute value of the angle formed by the slow axis of the cholesteric liquid crystal layer at a wavelength of 650 nm with respect to the slow axis of the cholesteric liquid crystal layer at a wavelength of 550 nm, the angle B may be in the range of 0° to 5°.

When both the angle A and the angle B are less than or equal to 5°, the degree of absorption of green light may be increased such that the reflected color value becomes green on the entire screen and there is no difference in reflected color value between the left and right sides.

If (e.g., when) the angle A is less than or equal to 5° and the angle B is greater than 5°, there can be a problem in that side reflectivity may be increased and a reflected color on a lateral side may be biased towards a reddish/bluish color.

If (e.g., when) the angle B is less than or equal to 5° and the angle A is greater than 5°, there can be a problem in that side reflectivity may be increased and a reflected color on a lateral side may be biased towards a reddish/bluish color.

In one or more embodiments, the angle A may be in the range of 0° to 5°, for example, greater than 0° and less than or equal to 5°, 0° to 4.5°, and 2° to 4.5°. In one or more embodiments, the angle B may be in the range of 0° to 5°, for example, greater than 0° and less than or equal to 5°, 0° to 3°, and 0° to 1°. Within these ranges, the polarizing plate may be easily manufactured.

In one or more embodiments, at least one of the angle A or the angle B may be greater than 0°.

Each of the slow axis of the cholesteric liquid crystal layer at a wavelength of 450 nm, the slow axis thereof at a wavelength of 550 nm, and the slow axis thereof at a wavelength of 650 nm may be measured using an AxoScan measurement device.

The angle A and the angle B may be realized by controlling a content (e.g., amount) of a chiral agent used in a process of preparing the cholesteric liquid crystal layer. This process will be described in more detail below.

The cholesteric liquid crystal layer may have a slow axis at a wavelength of 450 nm, a slow axis at a wavelength of 550 nm, and a slow axis at a wavelength of 650 nm, which are different from one another. That is, the angles formed by the slow axes at wavelengths of 450 nm, 550 nm, and 650 nm with respect to a light absorption axis (i.e., absorption axis) of the polarizer may be different.

In one or more embodiments, the cholesteric liquid crystal layer may satisfy Relation 1. As a result, the polarizing plate may reduce side reflectivity and allows the reflected colors to appear green.

$$A 450 > A 550 \geq A 650 \qquad Relation 1$$

where A450 is an absolute value of an angle formed by the slow axis of the cholesteric liquid crystal layer with respect to the absorption axis of the polarizer at a wavelength of 450 nm,
A550 is an absolute value of an angle formed by the slow axis of the cholesteric liquid crystal layer with respect to the absorption axis of the polarizer at a wavelength of 550 nm, and
A650 is an absolute value of an angle formed by the slow axis of the cholesteric liquid crystal layer with respect to the absorption axis of the polarizer at a wavelength of 650 nm.

In one or more embodiments, the cholesteric liquid crystal layer may satisfy Relation 1-1:

$$A 450 > A 550 > A 650 \qquad Relation 1 - 1$$

where A450, A550, and A650 are each the same as defined in Relation 1.

In Relation 1, A450 may be in the range of 45° to 50°, for example, 46° to 49°, for example, 47° to 49°; A550 may be in the range of 44° to 47°, for example, 44° to 46°, for example, 45° to 46°; and A650 may be in the range of 43° to 46°, for example, 44° to 46°, for example, 45° to 46°. Within these ranges, the angle A and the angle B may be easily achieved.

In one or more embodiments, the cholesteric liquid crystal layer may satisfy Relation 2. Aa a result, the polarizing plate may reduce side reflectivity and allows the reflected colors to appear green.

$$B 450 < B 550 < B 650 \qquad Relation 2$$

where B450 is in-plane retardation of the cholesteric liquid crystal layer at a wavelength of 450 nm,
B550 is in-plane retardation of the cholesteric liquid crystal layer at a wavelength of 550 nm, and
B650 is in-plane retardation of the cholesteric liquid crystal layer at a wavelength of 650 nm.

In Relation 2, B450 may be in the range of 100 nm to 150 nm, for example, 100 nm to 140 nm, for example, 100 nm to 130 nm; B550 may be in the range of 110 nm to 160 nm, for example, 110 nm to 150 nm, for example, 120 nm to 140 nm; and B650 may be in the range of 120 nm to 170 nm, for example, 120 nm to 160 nm, for example, 130 nm to 160 nm. Within these ranges, the cholesteric liquid crystal layer may be easily manufactured.

The cholesteric liquid crystal layer may have a thickness of 10 μm or less, for example, greater than 0 μm and less than or equal to 10 μm.

The cholesteric liquid crystal layer may include a cholesteric liquid crystal (CLC) region having cholesteric alignment of liquid crystals. The CLC region may be a liquid crystal region with a helical structure in which liquid crystal molecules are aligned in layers with directors of the liquid crystal molecules twisted along a helical axis.

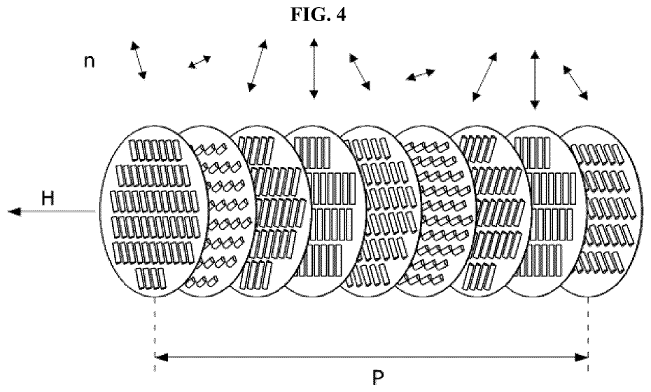

FIG. 4 shows an example cholesteric alignment liquid crystal layer according to one or more embodiments.

Referring to FIG. 4, the CLC region has a helical structure in which the liquid crystal molecules (n in FIG. 4) are aligned in layers, with the directors of the liquid crystal molecules twisted along the helix axis (H in FIG. 4). A distance (P in FIG. 4) in which the directors of the liquid crystal molecules complete a 360-degree rotation in the structure of the CLC region is referred to as “pitch”. Herein, the term “CLC region” may refer to a region in which the directors of the CLC molecules complete a 360-degree rotation. The directors of the liquid crystal molecules may refer to a slow axis direction. For example, the directors of the liquid crystal molecules may mean a normal direction of a disc for discotic liquid crystals, or a major axis direction of a rod shape for rod-shaped liquid crystals.

The cholesteric liquid crystal layer may be obtained by maintaining a cholesteric liquid crystal phase. The structure in which the cholesteric liquid crystal phase is maintained is preferably a structure in which alignment of a liquid crystal compound constituting the cholesteric liquid crystal phase is supported, for example, is a structure in which a polymerizable liquid crystal compound becomes an aligned state of the cholesteric liquid crystal phase and is then polymerized and cured to form a non-liquid layer through irradiation with UV light, heat, and the like, while being changed to a state in which alignment of the cholesteric liquid crystal molecules is not changed by external load or force. In addition, the structure in which the cholesteric liquid crystal phase is maintained may be any structure in which optical properties of the cholesteric liquid crystal phase are maintained and the liquid crystal compound needs not to exhibit liquid crystallinity. For example, in one or more embodiments, the polymerizable liquid crystal compound may be polymerized to lose liquid crystallinity by curing reaction.

A material for the cholesteric liquid crystal structure may include a liquid crystal composition containing a liquid crystal compound. In one or more embodiments, the liquid crystal compound includes a polymerizable liquid crystal compound.

In one or more embodiments, the liquid crystal composition containing the polymerizable liquid crystal compound further includes a surfactant, a chiral agent, and a polymerization initiator.

The polymerizable liquid crystal compound may be either a rod-shaped liquid crystal compound or a discoidal liquid crystal compound. Non-limiting examples of polymerizable groups included in the polymerizable liquid crystal compound may include an acryloyl group, a methacryloyl group, an epoxy group, a vinyl group, and/or the like. By curing the polymerizable liquid crystal compound, alignment of the liquid crystal compound may be secured. A liquid crystal compound having a polymerizable group may be a monomer or a relatively low molecular weight liquid crystal compound having a degree of polymerization of less than 100.

The discoidal liquid crystal compound may be, for example, a compound having a triphenylene structure. On the other hand, since a discoidal liquid crystal compound having a 3-substituted benzene structure has a greater Δn (birefringence) than the discoidal liquid crystal compound having a triphenylene structure and may broaden a selective reflection wavelength range, the discoidal liquid crystal compound having a triphenylene structure may be suitably selected, as needed.

The rod-shaped liquid crystal compound may include azomethines, azoxies, cyanobiphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, and/or alkenyl cyclohexyl benzonitriles.

The chiral agent may include at least one of a levorotatory chiral agent or a dextrorotatory chiral agent. In one or more embodiments, the chiral agent is a levorotatory chiral agent.

The chiral agent may be present in an amount of 1 part by weight to 4 parts by weight, for example, 3 parts by weight to 4 parts by weight, relative to 100 parts by weight of the polymerizable liquid crystal compound. Within this range, the chiral agent may easily reach the cholesteric liquid crystal layer.

The angle A and the angle B of the cholesteric liquid crystal layer may be controlled according to the content (e.g., amount) of the chiral agent.

### Retardation Layer

In one or more embodiments, the retardation layer may include the cholesteric liquid crystal layer alone.

In one or more embodiments, the retardation layer may include the cholesteric liquid crystal layer and a protective layer on at least one surface of the cholesteric liquid crystal layer.

The protective layer may be substantially the same as described below.

### Polarizer

The polarizer serves to reduce reflected colors and reflectivity over the entire viewing angle by linearly polarizing external light or light incident from a retardation stack.

The polarizer may have a degree of polarization of 99% or more. By simultaneously satisfying this degree of polarization and single light transmittance (Ts), the polarizer may significantly reduce reflectivity when stacked on the retardation stack. The “single light transmittance” refers to a single light transmittance (Ts) measured in the visible light spectrum, for example, at a wavelength of 400 nm to 700 nm, and may be measured by a typical method known to those skilled in the art. The degree of polarization may be measured by any method known to those skilled in the art. For example, the polarizer may have a degree of polarization of 99% to 99.9999%.

The polarizer may have a cross transmittance of 1% or less at a wavelength of 600 nm. Within this range, the polarizer may easily reach the cross transmittance at a wavelength of 600 nm described above.

The polarizer may have a thickness of 5 μm to 40 μm. Within this range, the polarizer may be used in the polarizing plate.

The light absorption axis of the polarizer may correspond to a stretching direction, for example, the machine direction (MD) of the polarizer, when the polarizer is manufactured from a polyvinyl alcohol film.

In one or more embodiments, the polarizer may include a polyvinyl alcohol-based polarizer manufactured by uniaxially stretching a polyvinyl alcohol film. In one or more embodiments, the polarizer may be manufactured by dyeing, stretching, crosslinking, and color correction of the polyvinyl alcohol film.

To manufacture a polarizing plate having a cross transmittance of 1% or less at a wavelength of 600 nm, the polarizer may be manufactured by the following method.

The polyvinyl alcohol film may be any typical polyvinyl alcohol film known to those skilled in the art.

In one or more embodiments, the polyvinyl alcohol film contains hydrophilic functional groups and hydrophobic functional groups. The hydrophobic functional groups are present together with the hydrophilic functional groups in the polyvinyl alcohol film, which are hydroxyl groups (OH groups).

The hydrophobic functional groups may be present in at least one of a main chain or a side chain of a polyvinyl alcohol resin constituting the polyvinyl alcohol film. Here, the main chain refers to a part constituting a main backbone of the polyvinyl alcohol resin, and the side chain refers to a backbone or a chain connected to the main chain. In one or more embodiments, the hydrophobic functional groups are present in the main chain of the polyvinyl alcohol resin.

The polyvinyl alcohol resin with the hydrophilic and hydrophobic functional groups introduced thereinto may be prepared by polymerizing one or more vinyl ester monomers, such as vinyl acetate, vinyl formate, vinyl propionate, vinyl butyrate, vinyl pivalate, isopropenyl acetate, and/or the like, with a monomer providing a hydrophobic functional group. In one or more embodiments, the vinyl ester monomer includes vinyl acetate. The monomer providing the hydrophobic functional group may include a monomer providing hydrocarbon repeat units including ethylene, propylene, and the like.

The polyvinyl alcohol film may have a thickness of 50 μm or less, for example, 10 μm to 50 μm. Within this range, the polyvinyl alcohol film does not suffer from melting and fracture in the stretching process.

The dyeing process includes treatment of a polyvinyl alcohol film in a dyeing bath containing a dichroic material. In the dyeing process, the polyvinyl alcohol film is dipped in the dyeing bath containing the dichroic material. The dyeing bath containing the dichroic material includes an aqueous solution containing the dichroic material and a boron compound (e.g., boric acid). As the dyeing bath includes both the dichroic material and a boron compound, the dyed polyvinyl alcohol film may be prevented from fracture when stretched under stretching conditions described below.

The dichroic material may include, as iodine, at least one selected from among potassium iodide, hydrogen iodide, lithium iodide, sodium iodide, zinc iodide, aluminum iodide, lead iodide, and copper iodide. The dichroic material may be present in an amount of 0.5 mol/ml to 10 mol/ml, for example, 0.5 mol/ml to 5 mol/ml, in the dyeing bath, for example, in the dyeing solution. Within this range, uniform dyeing may be achieved.

The boron compound may assist in prevention of melting and fracture of the polyvinyl alcohol film upon stretching of the polyvinyl alcohol film. The boron compound may assist in prevention of melting and fracture of the polyvinyl alcohol film in the subsequent stretching process even when the polyvinyl alcohol film is stretched at high temperature and high stretching ratio.

The boron compound may include at least one of boric acid or borax. The boron compound may be present in an amount of 0.1 wt % to 5 wt %, for example, 0.3 wt % to 3 wt %, in the dyeing bath, for example, in the dyeing solution. Within this range, the polyvinyl alcohol film does not suffer from melting and fracture in the stretching process and can achieve high reliability.

The dyeing solution may have a temperature of 20° C. to 50° C., for example, 25° C. to 50° C. The dyeing process may be performed by dipping the polyvinyl alcohol film in the dyeing bath for 30 seconds (sec) to 120 sec, for example, 40 sec to 80 sec.

The stretching process includes uniaxially stretching the dyed polyvinyl alcohol film at a stretching ratio of 5.7 times or more, for example, 5.7 times to 7 times, at 57° C. or more, for example, at 57° C. to 65° C.

The stretching process is performed by either wet stretching or dry stretching. In one or more embodiments, the stretching process includes wet stretching in order to apply the boron compound in the stretching process. Wet stretching includes uniaxial stretching of the polyvinyl alcohol film in an aqueous solution containing a boron compound in the machine direction.

The boron compound may include at least one of boric acid or borax. The boron compound may be present in an amount of 0.5 wt % to 10 wt %, for example, 1 wt % to 5 wt %, in a stretching bath, for example, in a stretching solution. Within this range, the polyvinyl alcohol film does not suffer from melting and fracture in the stretching process and may achieve high reliability.

The crosslinking process is performed to enhance adsorption of the dichroic materials to the stretched polyvinyl alcohol film. A crosslinking solution used in the crosslinking process includes a boron compound. The boron compound may assist in enhanced adsorption of the dichroic material described above while improving reliability of the polarizer even when the polarizer is left under thermal shock conditions.

The boron compound may include at least one of boric acid or borax. The boron compound may be present in an amount of 0.5 wt % to 10 wt %, for example, 1 wt % to 5 wt %, in a crosslinking bath, for example, in a crosslinking solution. Within this range, the adsorption of dichroic materials to the polyvinyl alcohol film is enhanced, and high reliability of the polyvinyl alcohol film may be achieved. The crosslinking solution may have a temperature of 20° C. to 55° C., for example, 25° C. to 55° C. The crosslinking process may be performed by dipping the polyvinyl alcohol film in the crosslinking bath for 30 sec to 120 sec, for example, for 40 sec to 80 sec.

The color correction process improves durability of the polyvinyl alcohol film. A color correction bath may contain 10 wt % or less, for example, 1 wt % to 5 wt %, for example, 3 wt % to 5 wt %, of potassium iodide. A color correction solution may have a temperature of 20° C. to 50° C., for example, 25° C. to 50° C. The color correction process may be performed by dipping the polyvinyl alcohol film in the color correction bath for 5 sec to 30 sec, for example, for 5 sec to 20 sec.

The drying process may be performed by treating the polyvinyl alcohol film at a temperature of 30° C. to 80° C., for example, 40° C. to 80° C., for 2 min or less, for example, for 1 minute to 2 minutes, after the correction process. The drying process may be performed by hot air drying, without being limited thereto.

In one or more embodiments, the polarizer having a cross transmittance of 1% or less at a wavelength of 600 nm may be realized by adjusting the conditions of the stretching process, for example, a stretching ratio, a stretching temperature, and/or the like. In one or more embodiments, the polarizer having a cross transmittance of 1% or less at a wavelength of 600 nm may be realized by adjusting the conditions of the color correction process and the drying process.

In one or more embodiments, the polyvinyl alcohol film may be further subjected to at least one of a washing process or a swelling process before the dyeing process.

In the washing process, the polyvinyl alcohol film is washed with water to remove foreign matter therefrom.

In the swelling process, the polyvinyl alcohol film is dipped in a swelling bath in a predetermined temperature range to facilitate dyeing with the dichroic material and stretching. The swelling process may be performed at 15° C. to 35° C., for example, at 20° C. to 30° C., for 30 sec to 50 sec.

In one or more embodiments, the polarizing plate may further include at least one lower protective layer on a lower surface of the polarizer. In one or more embodiments, the polarizing plate may further include at least one upper protective layer on an upper surface of the polarizer.

### Protective Layer

The protective layer may be stacked on the upper surface and/or the lower surface of the polarizer to protect the polarizer. The protective layer may protect the polarizer to increase reliability and mechanical strength of the polarizing plate. If (e.g., when) the mechanical properties of the polarizing plate can be secured without the protective layer, the protective layer may not be provided. The protective layer may be stacked in one or more layers on the upper surface and/or the lower surface of the polarizer.

The protective layer may include at least one of an optically transparent protective film or protective coating layers. The protective film (i.e., the optically transparent protective film) may include a film formed of one or more selected from among cellulose ester resins including triacetylcellulose (TAC) and/or the like, cyclic polyolefin resins including an amorphous cyclic olefin polymer (COP) and/or the like, polycarbonate resins, polyester resins including polyethylene terephthalate (PET) and/or the like, polyethersulfone resins, polysulfone resins, polyamide resins, polyimide resins, non-cyclic polyolefin resins, poly(meth)acrylate resins including poly(methyl methacrylate) and/or the like, polyvinyl alcohol resins, polyvinyl chloride resins, and polyvinylidene chloride resins, without being limited thereto.

The protective coating layer may be formed of an actinic radiation-curable resin composition including an actinic radiation-curable compound and a polymerization initiator. The actinic radiation-curable compound may include at least one selected from among a cationic polymerizable curable compound, a radical polymerizable curable compound, a urethane resin, and a silicone resin.

The protective layer may be formed of a retardation-free film or may have a predetermined range of in-plane retardation. For example, the protective layer may have an in-plane retardation of less than 5,000 nm, 5,000 nm or more, 120 nm to 160 nm, or 5 nm to 0 nm, at a wavelength of 550 nm. Within this range, the polarizing plate may be protected without affecting the effects of the retardation stack.

The protective layer may have a thickness of 10 μm or less, or 5 μm to 300 μm, 5 μm or less, or 5 μm to 200 μm. Within this range, the protective layer may be used in the polarizing plate.

In one or more embodiments, the polarizing plate may further include a functional coating layer formed on at least one surface of the protective layer. The functional coating layer may include at least one selected from among a hard coating layer, an anti-fingerprint layer, an antireflection layer, an antiglare layer, a low reflectivity layer, and an ultra-low reflectivity layer, without being limited thereto.

In one or more embodiments, the protective layer has a low moisture permeability to further improve durability of the polarizing plate after being left under high temperature/humidity conditions. For example, in one or more embodiments, the protective layer may have a moisture permeability of 1 g/m²·day or more, for example, 1 g/m²·day to 100 g/m²·day. Within this range, the polarizing plate may exhibit good durability, and the protective layer may be easily manufactured.

In one or more embodiments, at least one of a protective layer, an adhesive layer, or a bonding layer may be further arranged between the polarizer and the cholesteric liquid crystal layer and/or on a lower surface of the retardation stack.

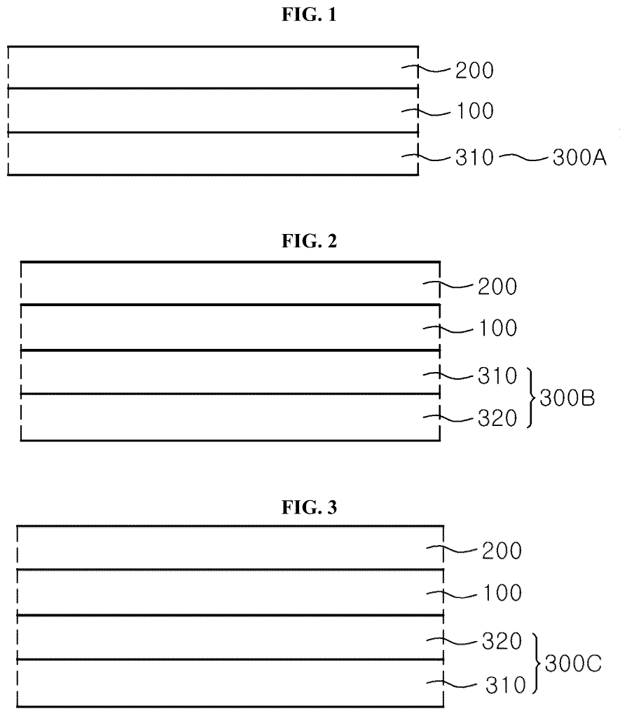

FIG. 1 to FIG. 3 are each a cross-sectional view of a polarizing plate according to embodiments of the present invention.

A polarizing plate according to one or more embodiments may include a polarizer 100, an upper protective layer 200 stacked on an upper surface of the polarizer 100, and a retardation layer 300A stacked on a lower surface of the polarizer 100, wherein the retardation layer 300A may include a cholesteric liquid crystal layer 310.

A polarizing plate according to one or more embodiments may include a polarizer 100, an upper protective layer 200 stacked on an upper surface of the polarizer 100, and a retardation layer 300B stacked on a lower surface of the polarizer 100, wherein the retardation layer 300B may include a cholesteric liquid crystal layer 310 and a lower protective layer 320.

A polarizing plate according to one or more embodiments may include a polarizer 100, an upper protective layer 200 stacked on an upper surface of the polarizer 100, and a retardation layer 3000 stacked on a lower surface of the polarizer 100, wherein the retardation layer 3000 may include a lower protective layer 320 and a cholesteric liquid crystal layer 310.

### Optical Display Apparatus

An optical display apparatus according to one or more embodiments of the present disclosure includes a polarizing plate according to one or more embodiments of the present disclosure.

The optical display apparatus may include a light emitting diode display. The light emitting diode may include at least one selected from among an organic light emitting diode, an inorganic light emitting diode, and an organic/inorganic light emitting diode.

Next, the present disclosure will be described in more detail with reference to some examples. However, it should be noted that these examples are provided for illustration only and are not to be construed in any way as limiting the present disclosure.

### Example 1

### (1) Manufacture of Polarizer

A polyvinyl alcohol film (VF-TS #4500, thickness: 45 μm, Kuraray Co., Ltd.) washed with water at 25° C. was subjected to swelling treatment with water in a swelling bath at 50° C.

After swelling treatment, the film was dipped in a dyeing bath, which was filled with an aqueous solution containing 1 mol/ml of potassium iodide and 1 wt % of boric acid, at 50° C. for 65 seconds. After dyeing treatment, the film was stretched at a stretching ratio of 5.7 times in a wet stretching bath filled with an aqueous solution containing 3 wt % of boric acid at 60° C. After stretching treatment, the film was subjected to crosslinking treatment in a crosslinking bath filled with an aqueous solution containing 3 wt % of boric acid at 55° C. for 65 seconds.

After crosslinking treatment, the film was subjected to color correction treatment in a color correction bath filled with a color correction solution (an aqueous solution containing 4.5 wt % of potassium iodide) at 50° C. for 10 seconds. After color correction treatment, the film was washed with water and dried with hot air at 80° C. for 1 minute, thereby preparing a polarizer (thickness: 17 μm).

### (2) Manufacture of Polarizing Plate

A triacetylcellulose film having an antiglare layer on one surface thereof was prepared as an upper protective layer of a polarizing plate.

A film having a cholesteric liquid crystal layer formed on one surface of the triacetylcellulose film was prepared. The cholesteric liquid crystal layer included a rod-shaped liquid crystal compound and a levorotatory chiral agent. The levorotatory chiral agent was present in an amount of 3 parts by weight relative to 100 parts by weight of the rod-shaped liquid crystal compound.

The upper protective layer was bonded to an upper surface of the polarizer by a bonding agent.

A polarizing plate was prepared by adhesively bonding the film having the cholesteric liquid crystal layer on one surface of the triacetylcellulose film to a lower surface of the polarizer.

Here, the film was bonded to the polarizer such that an angle of a slow axis of the cholesteric liquid crystal layer in an in-plane direction at a wavelength of 550 nm with respect to a light absorption axis of the polarizer was set as listed in Table 1. In this way, the angle of the slow axis of the cholesteric liquid crystal layer at wavelengths of 450 nm and 650 nm with respect to the light absorption axis of the polarizer could be given as listed in Table 1.

### Example 2

A polarizing plate was manufactured in substantially the same manner as in Example 1 except that angle A and angle B were changed by changing the content (e.g., amount) of the chiral agent to 3.2 parts by weight relative to 100 parts by weight of the rod-shaped liquid crystal compound.

### Example 3

A polarizing plate was manufactured in substantially the same manner as in Example 1 except that angle A and angle B were changed by changing the content (e.g., amount) of the chiral agent to 3.3 parts by weight relative to 100 parts by weight of the rod-shaped liquid crystal compound.

### Comparative Example 1

A polarizing plate was manufactured in substantially the same manner as in Example 1 except that angle A and angle B were changed by changing the content (e.g., amount) of the chiral agent to 6 parts by weight relative to 100 parts by weight of the rod-shaped liquid crystal compound.

### Comparative Example 2

A polarizing plate was manufactured in substantially the same manner as in Example 1 except that angle A and angle B were changed by changing the content (e.g., amount) of the chiral agent to 0.1 parts by weight relative to 100 parts by weight of the rod-shaped liquid crystal compound.

### Comparative Example 3

### (1) Manufacture of Polarizer

A polyvinyl alcohol film (VF-TS #4500, thickness: 45 μm, Kuraray Co., Ltd.) washed with water at 25° C. was subjected to swelling treatment with water in a swelling bath at 50° C.

After swelling treatment, the film was dipped in a dyeing bath, which was filled with an aqueous solution containing 1 mol/ml of potassium iodide and 1 wt % of boric acid, at 50° C. for 65 seconds. After dyeing treatment, the film was stretched at a stretching ratio of 5.7 times in a wet stretching bath filled with an aqueous solution containing 3 wt % of boric acid at 60° C. After stretching treatment, the film was subjected to crosslinking treatment in a crosslinking bath filled with an aqueous solution containing 3 wt % of boric acid at 55° C. for 65 seconds.

After crosslinking treatment, the film was subjected to color correction treatment in a color correction bath filled with a color correction solution (aqueous solution containing 2.8 wt % of potassium iodide) at 50° C. for 10 seconds. After color correction treatment, the film was washed with water and dried with hot air at 80° C. for 1 minute, thereby preparing a polarizer (thickness: 17 μm).

### (2) Manufacture of Polarizing Plate

A polarizing plate was manufactured in substantially the same manner as in Example 1 except that angle A and angle B were changed by changing the content of the chiral agent to 3.3 parts by weight relative to 100 parts by weight of the rod-shaped liquid crystal compound. A polarizing plate was prepared using the prepared polarizer in substantially the same manner as in Example 1.

### Reference Example 1

A polarizer was manufactured in substantially the same manner as in Example 1.

A triacetylcellulose film (Haze 15%, Toppan Co., Ltd.) having an antiglare layer on one surface thereof was prepared as an upper protective layer of a polarizing plate.

The upper protective layer was bonded to one surface of the polarizer. A polarizing plate was manufactured by sequentially stacking a negative dispersion retardation layer (positive A layer, liquid crystal layer) and a positive C layer (liquid crystal layer) on the other surface of the polarizer.

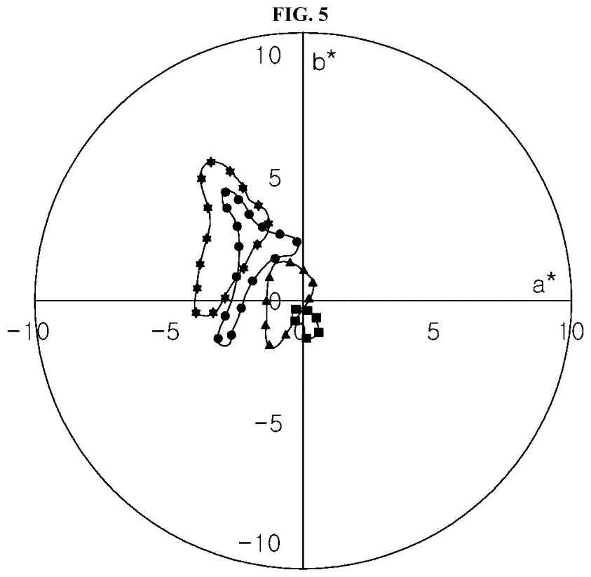

Each of the polarizing plates of Examples and Comparative Examples was evaluated as to the following properties and evaluation results are shown in Table 1, FIG. 5, and FIG. 6.
(1) Cross transmittance of polarizing plate: With each of the polarizing plates of Examples and Comparative Examples placed in a light transmittance measurement device V-7100, cross light transmittance at a wavelength of 600 nm was obtained by transmitting light from the upper protective layer side to the polarizer so as to travel in the normal direction to an in-plane direction of the polarizing plate.
(2) Reflected color values a* and b*: Reflected color values a* and b* on lateral sides (8°, 30°, 45°, and 60°) were obtained using a DMS-803 (Minolta Co., Ltd.) goniometer.

TABLE 1

| | | Example | | | Comparative Example | | | Reference |
|---|---|---|---|---|---|---|---|---|
| | | 1 | 2 | 3 | 1 | 2 | 3 | Example |
| Cross transmittance of | | 0.3 | 0.3 | 0.5 | 0.3 | 0.3 | 1.5 | 0.3 |
| polarizing plate at 600 | | | | | | | | |
| nm | | | | | | | | |
| Slow axis | @450 | 47.9 | 48.6 | 49.8 | 51.5 | 46.8 | 49.8 | — |
| angle* | nm | | | | | | | |
| | @550 | 45.1 | 45.3 | 45.6 | 45.5 | 45.3 | 45.6 | — |
| | nm | | | | | | | |
| | @650 | 45.0 | 45.3 | 45.4 | 44.8 | 38.2 | 45.4 | — |
| | nm | | | | | | | |
| Angle A | | 2.8 | 3.3 | 4.2 | 6.4 | 3.3 | 4.2 | — |
| Angle B | | 0.1 | 0 | 0.2 | 0.1 | 6 | 0.2 | — |
| In-plane | @450 | 115 | 116 | 118 | 132 | 116 | 118 | — |
| retardation* | nm | | | | | | | |
| | @550 | 139 | 140 | 141 | 139 | 140 | 141 | — |
| | nm | | | | | | | |
| | @650 | 150 | 152 | 153 | 150 | 142 | 153 | — |
| | nm | | | | | | | |
| @8° | a* | 0 | 0 | 0 | 0 | 0 | 0 | 0.1 |
| | b* | −0.2 | −0.3 | −0.2 | −0.3 | −0.3 | −0.2 | −0.3 |
| @30° | a* | −1 | −1 | −1 | −1 | 0.1 | 0.1 | 0.2 |
| | b* | 0 | 0.2 | 0.3 | −0.2 | 0.2 | −0.1 | −1.9 |
| @45° | a* | −2 | −2.1 | −2.5 | −2 | 0.5 | 0.5 | 0.5 |
| | b* | 2.5 | 2.7 | 3 | −1 | −2.5 | −1.5 | −2.5 |
| @60° | a* | −3 | −3.2 | −3.5 | −3 | 0.7 | 0.7 | 0.7 |
| | b* | 3.5 | 3.4 | 3.7 | −5.8 | −5.1 | −2.1 | −3.5 |

*Slow axis angle: Angle of the slow axis of the cholesteric liquid crystal layer with respect to the light absorption axis of the polarizer at the corresponding wavelength.
*In-plane retardation: In-plane retardation of the cholesteric liquid crystal layer.

As shown in Table 1, each of the polarizing plates of Examples could minimize a difference in reflected color depending on viewing angle by allowing a screen to appear green while preventing blue and red colors from being visible as reflected colors on lateral sides thereof when applied to an optical display apparatus.

In contrast, the polarizing plates of Comparative Examples had insignificant effects, as compared with the polarizing plates of Examples.

FIG. 5 is a graph depicting evaluation results of reflected color values a* and b* in application of the polarizing plate of Example 1. Referring to FIG. 5, it can be seen that the reflected color values have become green overall.

FIG. 6 is a graph depicting evaluation results of reflected color values a* and b* in application of the polarizing plate of Reference Example. Referring to FIG. 6, it can see that the reflected color values have become blue and red on the entire screen.

In the present disclosure, it will be understood that the term “comprise(s)/comprising,” “include(s)/including,” or “has(have)/having” specifies the presence of stated features, numbers, steps, operations, elements, and/or components, but do not preclude the presence or addition of one or more other features, numbers, steps, operations, elements, components, and/or groups thereof. Additionally, the terms “comprise(s)/comprising,” “include(s)/including,” “has(have)/having,” or other similar terms include or support the terms “consisting of” and “consisting essentially of,” indicating the presence of stated features, numbers, steps, operations, elements, and/or components, without or essentially without the presence of other features, numbers, steps, operations, elements, components, and/or groups thereof. Further, the use of “may” when describing embodiments of the present disclosure refers to “one or more embodiments of the present disclosure”.

In the present disclosure, expressions such as “at least one of,” “one of,” and “selected from,” when preceding a list of elements, modify the entire list of elements and do not modify the individual elements of the list. For example, “at least one of a, b or c”, “at least one selected from among a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. In addition, when reference is made to “A and/or B” or “A or B” or “A/B” throughout the disclosure, it means A, B, or A and B unless otherwise particularly stated to the contrary.

It should be understood that, even if the terms “about,” “approximately,” or “substantially” are not expressly recited in a given element (e.g., a claim element), the scope of such element is intended to include variations that are insubstantial or within the understanding of one of ordinary skill in the art. For example, numerical values and ranges provided herein are intended to include tolerances and measurement uncertainties that would be recognized by those skilled in the art, and the elements (e.g., claim elements) should be construed accordingly to encompass such equivalents.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims and equivalents thereof.

What is claimed is:

1. A polarizing plate, comprising:
a polarizer; and
a retardation layer on a surface of the polarizer,
wherein the polarizing plate has a cross transmittance of 1% or less at a wavelength of 600 nm,
the retardation layer comprises a cholesteric liquid crystal layer,
an angle (angle A) formed by a slow axis of the cholesteric liquid crystal layer at a wavelength of 450 nm with respect to a slow axis of the cholesteric liquid crystal layer at a wavelength of 550 nm is less than or equal to 5°, and
an angle (angle B) formed by a slow axis of the cholesteric liquid crystal layer at a wavelength of 650 nm with respect to the slow axis of the cholesteric liquid crystal layer at a wavelength of 550 nm is less than or equal to 5°.

2. The polarizing plate as claimed in claim 1, wherein the polarizing plate has a single light transmittance of 40% to 47% at a wavelength of 550 nm.

3. The polarizing plate as claimed in claim 1, wherein the polarizing plate has a single light transmittance of 3% or less at a wavelength of 380 nm.

4. The polarizing plate as claimed in claim 1, wherein,
the angle A formed by the slow axis of the cholesteric liquid crystal layer at a wavelength of 450 nm with respect to the slow axis of the cholesteric liquid crystal layer at a wavelength of 550 nm of the cholesteric liquid crystal layer is in a range of 0° to 5°, and
the angle B formed by the slow axis of the cholesteric liquid crystal layer at a wavelength of 650 nm with respect to the slow axis of the cholesteric liquid crystal layer at a wavelength of 550 nm of the cholesteric liquid crystal layer is in a range of 0° to 5°.

5. The polarizing plate as claimed in claim 1, wherein at least one of the angle A or the angle B is greater than 0°.

6. The polarizing plate as claimed in claim 1, wherein the cholesteric liquid crystal layer satisfies Relation 1:
$$A 450 > A 550 \geq A 650 , \qquad Relation 1$$
where A450 is an absolute value of an angle formed by the slow axis of the cholesteric liquid crystal layer with respect to an absorption axis of the polarizer at a wavelength of 450 nm,
A550 is an absolute value of an angle formed by the slow axis of the cholesteric liquid crystal layer with respect to the absorption axis of the polarizer at a wavelength of 550 nm, and
A650 is an absolute value of an angle formed by the slow axis of the cholesteric liquid crystal layer with respect to the absorption axis of the polarizer at a wavelength of 650 nm.

7. The polarizing plate as claimed in claim 6, wherein, in Relation 1, A450 is in a range of 45° to 50°, A550 is in a range of 44° to 47°, and A650 is in a range of 43° to 46°.

8. The polarizing plate as claimed in claim 1, wherein the cholesteric liquid crystal layer satisfies Relation 2:
$$B 450 < B 550 < B 650 , \qquad Relation 2$$
where B450 is in-plane retardation of the cholesteric liquid crystal layer at a wavelength of 450 nm,
B550 is in-plane retardation of the cholesteric liquid crystal layer at a wavelength of 550 nm, and
B650 is in-plane retardation of the cholesteric liquid crystal layer at a wavelength of 650 nm.

9. The polarizing plate as claimed in claim 8, wherein, in Relation 2, B450 is in a range of 100 nm to 150 nm, B550 is in a range of 110 nm to 160 nm, and B650 is in a range of 120 nm to 170 nm.

10. The polarizing plate as claimed in claim 1, wherein the cholesteric liquid crystal layer has a thickness of 10 μm or less.

11. The polarizing plate as claimed in claim 1, wherein the cholesteric liquid crystal layer comprises a polymerizable liquid crystal compound and a levorotatory chiral agent.

12. The polarizing plate as claimed in claim 11, wherein the levorotatory chiral agent is in an amount of 1 part by weight to 4 parts by weight based on 100 parts by weight of the polymerizable liquid crystal compound.

13. The polarizing plate as claimed in claim 11, wherein the polymerizable liquid crystal compound comprises at least one of a rod-shaped liquid crystal compound or a discoidal liquid crystal compound.

14. The polarizing plate as claimed in claim 1, wherein the retardation layer comprises the cholesteric liquid crystal layer alone.

15. The polarizing plate as claimed in claim 1, wherein the retardation layer comprises the cholesteric liquid crystal layer and a protective layer on at least one surface of the cholesteric liquid crystal layer.

16. An optical display apparatus comprising the polarizing plate as claimed in claim 1.
